(19) United States
(12) Patent Application Publication
(10) Pub. No.: US 2008/0292483 A1
(43) Pub. Date: Nov. 27, 2008

(54) Gas Volume Damping Device for Damping Discharge Pulsations in a Medium Being Pumped

(75) Inventor: Cornelius Johannes De Koning, Venlo (NL)

Correspondence Address: Muncy, Geissler, Olds & Lowe, PLLC, P.O. BOX 1364, FAIRFAX, VA, 22038-1364, US

(73) Assignee: WEIR MINERALS NETHERLANDS B.V., Venlo (NL)

(21) Appl. No.: 12/097,397

(22) PCT Filed: Dec. 8, 2006
(86) PCT No.: PCT/NL2006/000623

§ 371 Date: Jul. 16, 2008

(30) Foreign Application Priority Data
Dec. 14, 2005 (NL) 1030669

(51) Int. Cl. F04B 11/00; F16L 55/04; F16L 55/053

(52) U.S. Cl. 417/540; 417/542; 138/30

(57) ABSTRACT

The invention relates to a device for damping discharge pulsations in a medium being pumped through a system of pipes in a pulsating manner by a displacement pump that operates with a specific discharge characteristic, which device at least comprises a housing with an at least partially gas-filled damping chamber having a certain volume present therein, which housing can be connected to the system of pipes, in such a manner that an interface layer is present between the medium and the gas in the damping chamber during operation, which damping chamber has a desired gas pressure characteristic that partially depends on the discharge characteristic of the displacement pump, wherein the gas volume that is present in the damping chamber varies in time between a minimum compression volume and a maximum expansion volume under the influence of said discharge pulsations during operation, as well as adjusting means that supply gas to or discharge gas from the damping chamber The present invention provides a simpler and less complicated construction both for pulsation dampers provided with a separating element and for air boxes not provided with a separating element. In order to achieve an optimised damping of the discharge pulsations, the adjusting means are according to the invention arranged for determining the desired gas pressure characteristic in the damping chamber on the basis of the discharge characteristic of the displacement pump and determining the current gas pressure characteristic in the damping chamber, and comparing the current gas pressure characteristic as determined with the desired gas pressure characteristic of the damping chamber and determining the current position of the interface layer in the damping chamber on the basis of said comparison.

The invention relates to a device for damping discharge pulsations in a medium being pumped through a system of pipes in a pulsating manner by a displacement pump that operates with a specific discharge characteristic, which device at least comprises a housing with an at least partially gas-filled damping chamber having a certain volume present therein, which housing can be connected to the system of pipes, in such a manner that an interface layer is present between the medium and the gas in the damping chamber during operation, which damping chamber has a desired gas pressure characteristic that partially depends on the discharge characteristic of the displacement pump, wherein the gas volume that is present in the damping chamber varies in time between a minimum compression volume and a maximum expansion volume under the influence of said discharge pulsations during operation, as well as adjusting means that supply gas to or discharge gas from the damping chamber.

The invention also relates to a method for damping discharge pulsations in a medium being pumped through a system of pipes in a pulsating manner by a displacement pump that operates with a specific discharge characteristic, using a gas volume damping device according to the invention, which is connected to the pipe, wherein an interface layer is formed during standstill between the medium and the gas in a gas-filled damping chamber having a certain volume, and wherein the gas volume present in the damping chamber varies in time between a minimum compression volume and a maximum expansion volume under the influence of said discharge pulsations during operation, and wherein gas is supplied to or discharged from the damping chamber for compensating the ideal average gas volume in case of changes in the operating pressures.

Pulsating volume flows being pumped through a pipe are often imposed by displacement pumps, which on average generate a volume flow that is constant and substantially pressure-independent, to be true, but which strongly pulsates with every delivery cycle, however. The pressure pulsations generated as a result of said discharge pulsations in turn lead to large dynamic forces, large movements or vibrations in the pipe or in its mounting and support constructions, depending on the frequency of said pulsations. Depending on the length of the pipe, a pulsating volume flow in a pipe generates a strongly pulsating pressure upstream in the pipe as a result of acceleration and deceleration forces caused by the volume flow mass.

The risk of failure due to fatigue is very great. It is common practice, therefore, to provide such pumps with a damping device as referred to in the introduction, which device is arranged for damping the discharge pulsations in the pipe. Known damping devices are usually referred to as gas volume pulsation dampers.

With said gas volume pulsation dampers, the greater than average volume flow that is generated by the pump is compensated by accumulation and compression of the gas that is present in the damping chamber and the smaller than average volume flow is compensated by the discharge of liquid from the damping chamber through expansion of the gas. Known embodiments of gas volume pulsation dampers are air boxes and membrane pulsation dampers.

In the case of air boxes the gas, usually air, is in direct contact with the liquid medium. In the case of membrane pulsation dampers, the gas is separated from the liquid medium by an elastic separation membrane. Furthermore there are so-called “piston pulsation dampers”, in which a freely movable piston forms the separation between the gas and the liquid. The provision of a mechanical separating element prevents direct contact between the gas and the liquid, and thus absorption of the gas by the liquid.

When air boxes are used, it is not possible to use a gas preload prior to the starting of the installation. As a consequence, the volume of the air box is usually large, since a large part of the volume of the air box is already used up after compression of the (atmospheric) air to the average operating pressure. The gas volume at the average operating pressure determines the damping capacity of the damper.

One possibility of preloading an air box with gas during operation is to realise this by means of a level measurement of the liquid in the air box/damping chamber. By supplying gas under pressure, the average liquid level in the air box can be maintained at a substantially constant level and the liquid volume can be kept sufficiently small, so that sufficient damping gas volume will nevertheless remain, independently of the pressure. As already said before, a drawback of the air box with its direct gas-liquid contact is that the gas is slowly absorbed by the liquid medium and that an increasingly smaller damping gas volume will remain if no countermeasures, such as the aforesaid level control, are taken.

The gas preload is optimal in case of a maximum gas volume, i.e. the liquid volume at average operating pressure must be such that when the pump delivery is temporarily lower than average, the volume that needs to be delivered will still be available with a sufficient margin. This is based on a constant average operating pressure, however. If said average operating pressure varies as a result of any changes in the operating conditions, this must be taken into account in the gas preload, and a lower preload pressure must be used. As a result, the preload will not be optimal during the higher average operating pressure, and a smaller damping gas volume will remain.

Practical gas preload pressures range between 50% and 80% of the average maximum operating pressure and, in case of a larger variation of the operating pressure, up to 30% of the average maximum operating pressure. With preloads of less than 30%, the remaining damping gas volume at maximum average operating pressure is too small to achieve an adequate damping effect, or an excessively large damper in relation to the pump size must be selected, which leads to high costs.

A solution for this is to provide a “level” measurement for the known pulsation damper fitted with a separating element as well, and to supply or discharge gas in response to said measurement. One method is to control the gas charge in the damping chamber on the basis of the current position of the interface layer between the medium and the gas, for example the central part of the membrane, or on the basis of the current position of the separating element. The current position of the interface layer is related to the liquid volume that is present in the damping chamber.

An embodiment of a gas volume pulsation damper as referred to in the introduction is known, for example from German patent publication No. 40 31 239 A1. In said patent publication, the interface layer between the gas and the medium to be pumped in the damping chamber is formed by a separation membrane, to which a rod is connected. Said rod is carried outwards through a cover of the housing. The current membrane positions are detected via magnetic switches during operation, and gas is added to or removed from the gas volume in the damping chamber in dependence thereon. By controlling the gas volume in this manner, the membrane position will remain between its two maximum positions, which has a positive effect on the operation as well as on the working life of the device.

A drawback of such a membrane position detection is the mechanical nature thereof. Furthermore, the known gas volume pressure pulsation damping device comprises moving parts, which are very liable to wear as a result of the very dynamic movements of the membrane. The moving rod must furthermore be dynamically sealed against high gas pressures, or the space outside the housing in which the rod moves must be pressure-tight. With this construction, the magnetic switches must switch through a thick metal wall, however, which is complex and costly.

Other membrane or separating element position measurements may be carried out in a contactless manner through the cover by making use of infrared distance measurement, ultrasonic measurement or other techniques. It is also possible to measure through the wall of the housing by using radioactivity and thus determine the position of the membrane or the separating element. The use of radioactive material has several practical drawbacks, however, whilst in addition it is costly.

The present invention provides a simple and cost-saving solution both for pulsation dampers provided with a separating element and for air boxes not provided with a separating element. In order to achieve an optimised damping of the discharge pulsations, the adjusting means are according to the invention arranged for determining the current gas pressure characteristic in the damping chamber and comparing the current gas pressure characteristic as determined with the desired gas pressure characteristic of the damping chamber and determining the current position of the interface layer in the damping chamber on the basis of said comparison.

According to the invention, the adjusting means are in particular arranged for determining the desired gas pressure characteristic of the damping chamber partially on the basis of the discharge characteristic of the displacement pump, and more specifically the adjusting means are arranged for determining the position of the interface layer in the damping chamber at average pressure on the basis of the chamber volume and the compression and expansion pressure associated with the compression and expansion gas volume.

The pressure pulsation can be damped in a more effective and precise manner by making use of the determined gas pressure characteristic in the damping chamber.

A special embodiment of the invention is characterised in that the adjusting means comprise at least one pressure sensor.

The device according to the invention is further characterised in that the interface layer between the pulsating volume flow and the gas is formed by a separating element.

In a specific embodiment, the damping chamber may be an air box, whilst furthermore the damping chamber may be provided with a membrane as the interface layer between the medium and the gas.

The method according to the invention is characterised in that, for the purpose of damping the discharge pulsations, the desired gas pressure characteristic of the damping chamber is determined, the current gas pressure characteristic in the damping chamber is determined and compared with the desired gas pressure characteristic, and in that the average position of the interface layer in the damping chamber is determined on the basis of said comparison.

In a special embodiment of the method according to the invention, the desired gas pressure characteristic of the damping chamber is determined on the basis of the discharge characteristic.

More specifically, the current position of the interface layer in the damping chamber is determined on the basis of the discharge characteristic of the pump, the chamber volume and a desired position of the interface layer in the damping chamber at average pressure.

The method is further characterised in that the compression and expansion pressure associated with the compression and expansion gas volume are determined on the basis of the discharge characteristic of the pump, the chamber volume and the position of the interface layer in the damping chamber at average pressure.

Both the air box and the pulsation damper fitted with separating elements have a specific volume determined by their geometric configuration, which volume is known. The delivery characteristic of the pump that is used is known as well. It has surprisingly been found that by using a displacement pump having a known characteristic in combination with the known volume of the damping chamber of the device according to the invention and with an assumed amount of liquid (medium) considered to be minimal in the damping chamber (being the position of the interface layer in the damping chamber at average pressure), the compression and the expansion pressure of the gas are in that case calculated at the extreme positions of the interface layer at which the gas in the damping chamber has its minimum compression volume and its maximum expansion volume, respectively.

The total pressure pulsation during a pump cycle is thus known. On the other hand, the pulsation levels that occur at different operating conditions can be measured for the installation in question and subsequently be used as reference points for the further control.

As an alternative to said calculation, the pulsation level that occurs at different operating conditions can be measured in the installations in question and subsequently be used as reference points in said control.

Thus, the current position of the interface layer between the medium and the gas can be indirectly determined by means of a simple pressure measurement in the damping chamber. On the basis of this knowledge the adjusting means according to the invention partially determine to what extent gas must be supplied to the damping chamber or be discharged therefrom so as to damp the currently occurring discharge/volume pulsation in an optimum manner with as little pressure pulsation as possible.

The invention further relates to a method as referred to in the introduction, which method is according to the invention characterised in that the pressure of the gas in the gas of volume pulsation damper is measured for the purpose of determining the position of the interface layer.

The invention will now be explained in more detail with reference to a drawing, in which:

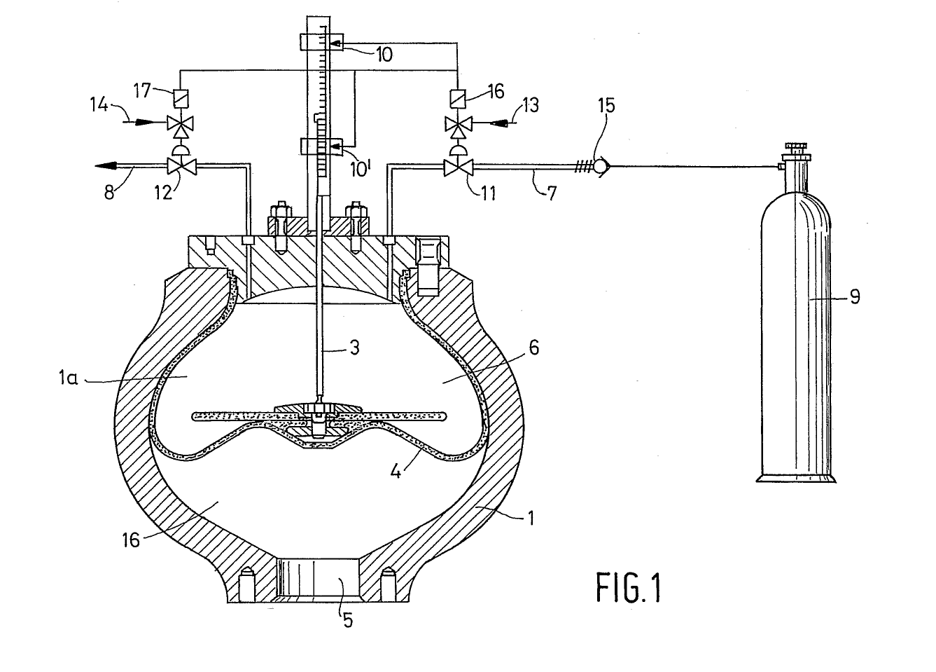

FIG. 1 shows an embodiment of a controllable gas volume pressure pulsation device according to the prior art;

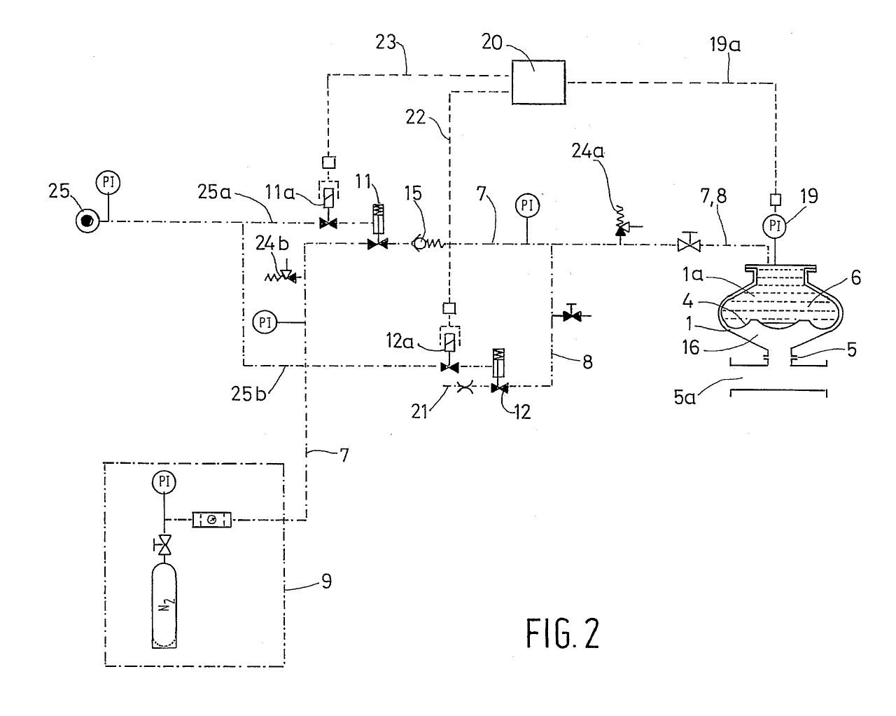

FIG. 2 shows a first embodiment of a controllable gas volume pressure pulsation device according to the invention;

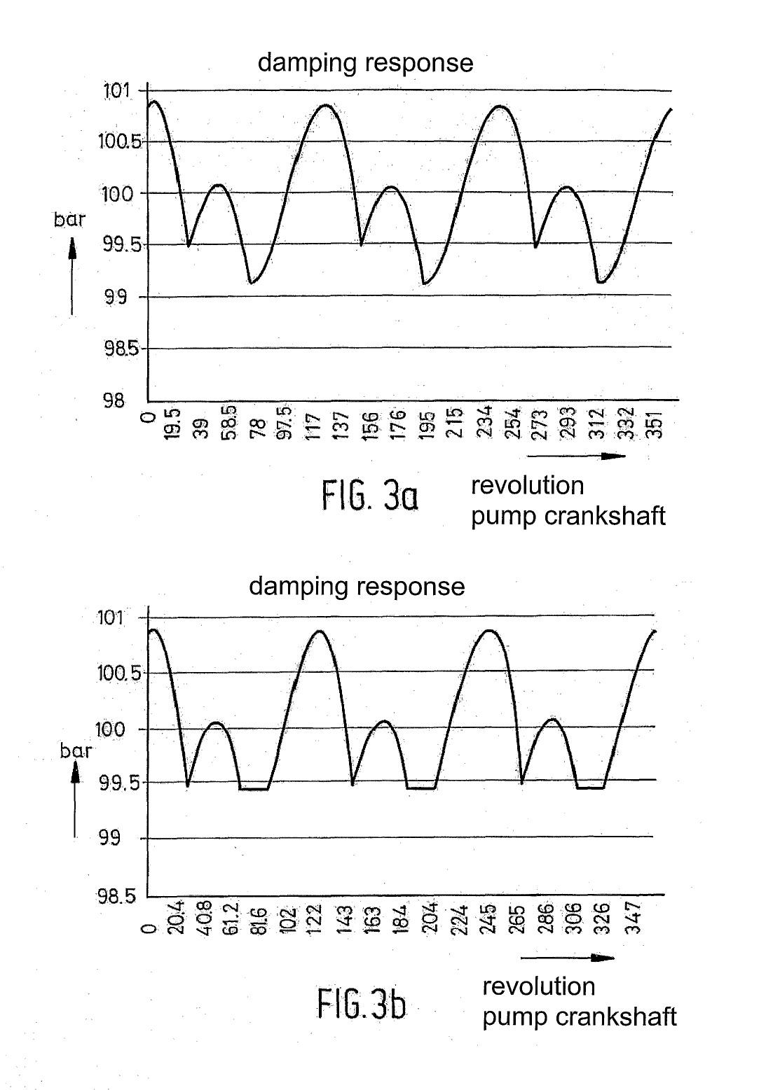

FIGS. 3 and 4 show different pressure pulsation characteristics for use in the control of the gas volume pressure pulsation device according to the invention.

In FIG. 1, a controllable gas volume pressure pulsation device according to the prior art is shown, and more in particular a gas volume pressure pulsation device as disclosed in German patent publication No. 40 31 239.

The known device comprises a housing 1, which encloses a damping chamber 6. The housing 1 can be connected to a pipe (not shown) by means of a connecting flange 5, through which pipe a liquid medium is pumped by means of a displacement pump. Such displacement pumps generate on average a constant, substantially pressure-independent volume flow of the medium through the pipe, to be true, but said volume flow pulsates strongly with each delivery cycle.

Besides, depending on the length of the pipe, a pulsating volume flow in a pipe generates a strongly pulsating pressure upstream in the pipe as a result of the acceleration and deceleration forces. Depending on the frequency, said pressure pulsations in turn lead to large dynamic forces, movements or vibrations in the pipe and/or in its mounting and supporting construction.

Such pressure pulsations inevitably lead to failure of the system of pipes due to fatigue. It is desirable, therefore, that the pressure pulsations in the pipe be damped during operation, for which purpose damping devices as disclosed in German patent publication No. 40 31 239 are used.

In the gas volume pulsation damping device that is currently known, a flexible membrane 4 is present in the housing 1, which membrane divides the damping chamber 6 into a sub-chamber 1b for the liquid medium to be pumped and a sub-chamber 1a for gas, which gas is screened from the liquid medium by the membrane 4. The liquid medium can flow into the sub-chamber 1b via the pipe 5a and the flange coupling 5.

An increase in the discharge leads to a necessary acceleration of the liquid mass in the upstream pipe portion, for which an additional mass force or pump pressure is in turn required, which leads to an accumulation of liquid medium in the sub-chamber 1b of the gas volume damper 1. Thus the acceleration/force is reduced to the value of the compression pressure by levelling down the peak discharge.

Likewise, a decrease in the pump discharge is compensated by discharging liquid medium from the sub-chamber 1b through expansion of the gas in the sub-chamber 1a. Thus, the membrane 4 will undergo an intermittent movement with every pump cycle, with the volume amount of medium increasing and the gas in the sub-chamber 1a simultaneously being compressed and a return flow of liquid medium into the pipe causing the gas in the sub-chamber 1a to expand.

An optimum damping effect, i.e. a minimum pressure increase and decrease upon absorption of the pulsating volume pump characteristic, is obtained when a maximum gas volume is available (according to the gas laws). That is, when the volume is maximal. Within the normal pumping function, the limit is determined by the separating element just not touching the bottom of the damping chamber 1a during a maximum volume discharge from the chamber.

The known gas volume pulsation damping device is to that end provided with means that supply gas to or discharge gas from the sub-chamber 1a for damping the pressure pulsations. Said means comprise a storage vessel 9 with gas that can be introduced into the sub-chamber 1a under pressure via a supply pipe 7. To that end a valve 11 is mounted in the supply pipe 7, which valve can be opened or closed by means of an actuating solenoid 13, 16.

Said means also comprise a discharge pipe 8 for discharging gas from the sub-chamber 1a to outside the gas volume pulsation device, in which discharge pipe 8 a valve 12 is furthermore mounted, which valve can be opened and closed by means of a solenoid 14, 17.

The membrane 4 in the damping chamber 6 is provided with a rod 3 that extends through the housing 1. During the intermittent movement of the membrane 4 in the damping chamber caused by the discharge pulsations of the liquid medium, the rod 3 will accordingly move into and out of the housing 1 of the device. The degree of movement and the movement position of the rod 3 (and consequently of the membrane 4) can be read from a graduation, on which graduation two magnetic switches 10 and 10′ are placed.

In case of an overly large deviation of the movement position of the membrane 4, one of the two magnetic switches 10-10′ is energized, as a result of which either the supply valve 11 or the discharge valve 12 is opened or closed. Thus, gas can be supplied to the sub-chamber 1a from the storage vessel 9 or be discharged from the sub-chamber 1a via the discharge pipe 8 on the basis of the movement position of the membrane 4.

A drawback of this known gas volume pulsation damping device is the fact that moving parts are used, in particular the moving rod 3, which extends through the housing 1. As a result, the membrane is no longer force-balance and encounters additional tension. This construction requires an adequate seal of the rod and the housing at the location of the housing 1 so as to prevent gas from escaping from the damping chamber 6 along the rod 3. The moving parts are very liable to wear on account of the highly dynamic movement of the membrane 4, whilst in addition the seal along the rod 3 must meet specific, high requirements.

When the rod is not carried outside, measurement and control must take place through the pressure wall, for which a complex and costly construction is needed.

Both embodiments require a sufficiently stable and thick rod and guide in order to maintain the central part of the membrane in a stable position.

FIG. 2 shows an embodiment of the gas volume pulsation damping device according to the invention, which does not have the currently known drawbacks of the prior art gas volume damping devices.

Those parts in FIG. 2 that correspond to parts shown in FIG. 1 are indicated by the same numerals as in FIG. 1.

In this embodiment the gas volume damping device is a membrane-type damping device, although it is also possible to use an air box as the gas volume damping device.

Analogously to the known device as shown in FIG. 1, the gas volume damping device according to the invention comprises a housing 1, which is connected by means of a flange to a pipe portion 5a that forms part of a larger system of pipes.

A liquid medium is pumped through said system of pipes by means of a displacement pump (not shown), with considerable discharge pulsations occurring in the volume flow during a pump cycle. The housing 1 is provided with a damping chamber 6, which is divided by a membrane 4 into a sub-chamber 1b for accumulating liquid medium from the pipe 5a and returning said liquid medium into the pipe 5a, and a sub-chamber 1a for the damping gas.

The means used for damping or adjusting the discharge pulsations that occur in the liquid medium and thus in the gas volume damping device at average operating pressure changes during every pump cycle include a storage vessel 9 filled with a pressurised gas, for example nitrogen N₂. Said storage vessel 9 is connected, via a supply pipe 7, to the sub-chamber 1 of the gas sub-chamber pulsation damping device for supplying gas into the sub-chamber 1a, for example for creating a gas pre-pressure.

A non-return valve 15 is mounted in the supply pipe 7 so as to prevent gas from flowing back in the direction of the storage vessel 9 via the supply pipe 7. A supply valve 11 is mounted upstream of the non-return valve 15, which supply valve can be opened and closed by a solenoid 11a. The solenoid 11a is connected to a control unit 20 by means of a suitable electrical connecting line 23, which control unit forms part of the adjusting means. The adjusting means according to the invention also comprise a discharge pipe 8 for the gas that is present in the sub-chamber 1a, which discharge pipe 8 can be opened and closed by means of a discharge valve 12. The discharge valve 12 is actuated by an electromagnetic solenoid 12a, which is connected to the aforesaid control unit 20 in a corresponding manner by means of an electrical connecting line.

In this embodiment a part of the supply pipe 7 also functions as a discharge pipe 8, which leads to a less complicated, simple construction, since only one pipe 7, 8 needs to be connected to the housing 1 of the gas volume pulsation damping device according to the invention.

When the discharge valve 12 is opened (through suitably energisation of the electromagnetic solenoid 12a by the control unit 20), gas present in the sub-chamber 1a can be discharged into the outside atmosphere via the supply/discharge pipe 7, 8, the discharge pipe 8 and a throttle valve 21.

It is also possible to collect the discharged gas again in a low-pressure storage tank and subsequently increase the gas pressure again by means of a compressor device, so that the gas can be used again for being supplied to a damper.

Likewise, the supply valve 11 can be opened through suitable energisation of the electromagnetic solenoid 11a by the control unit 20, so that the pressurised gas N₂ that is present in the storage vessel 9 can flow into the sub-chamber 1a of the gas volume pulsation damping device via the supply pipe 7 (causing the non-return valve 15 to open).

According to the invention, said controlling of the gas charge does not take place by means of a mechanical construction, but by means of a pressure sensor 19, which measures the current pressure of the gas in the sub-chamber 1a. More in particular, the pressure sensor 19 measures the current pressure with a sufficiently high frequency, so that also the current pressure pulsation characteristic or pattern in the damping chamber can be determined from this.

Said pressure sensor 19 is connected to the control unit 20 by means of an electrical connecting line 19a, which control unit 20 is so arranged that it compares the measured gas pressure characteristic with the known pressure characteristic of the pump on the basis of the electrical signal delivered by the pressure sensor 19, which signal represents the current gas pressure characteristic in the sub-chamber 1a.

On the basis of this comparison, it is possible to determine a change in the operating pressure and the current position of the interface layer between the gas and the liquid medium (in this case the physical membrane 4), and on the basis thereof the electromagnetic solenoid 12a or 11a is energised via the connecting line 22 or 23. The initial movement position of the membrane can be adapted by discharging gas from the sub-chamber 1a via the discharge pipe 8 and the thus opened discharge valve 12 or, in the case of the supply valve 11 being actuated and opened, by supplying pressurised gas from the storage vessel 9 to the sub-chamber 1a of the gas volume pulsation damping device via the supply pipe 7.

In this way the membrane is prevented from moving beyond the desired operating positions upon damping the discharge pulsations, which may on the one hand lead to the membrane being damaged as a result of repeatedly coming into contact with the wall of the damping chamber at the bottom, whilst on the other hand a maximum gas volume is nevertheless present in the damper intended for a minimum pulsation when damping the discharge pulsations.

This will be explained by way of example with reference to FIGS. 3a and 3b.

FIG. 3a shows a damper response or the pressure pattern in the gas-filled damping chamber of a gas volume pulsation damping device according to the invention. The pressure pattern is plotted along the vertical axis against the revolution that the crankshaft of the pump makes during one stroke (revolution). Since the pressure pattern that is shown in FIG. 3a is caused by a multicylinder reciprocating pump, several peaks staggered in time are formed.

The pressure pattern that is shown in FIG. 3a is typical of a specific type of pump.

FIG. 3b shows a measured pressure pattern as can be determined with the method and the device according to the invention, for example by means of a pressure sensor that is disposed in the damping chamber. All kinds of deviations can be derived from the measured pressure pattern—by comparing it with the pressure pattern associated with the pump that is used or with the pressure characteristic as shown in FIG. 3a—on the basis of which deviations the current position of the interface layer in the damping chamber of the gas volume pulsation damping device can be determined.

As is clearly shown in FIG. 3b, the lowest peaks are flattened in comparison with the corresponding peaks in FIG. 3a, which are associated with the known pressure pattern or characteristic of the pump that is used. Based on this measured pressure characteristic, it can be determined that too much gas is present in the damping chamber, and that as a result of the intermittent movement of the interface layer (for example the membrane), the latter will strike against the inside wall of the damping chamber.

The state of the damping chamber, and more in particular of the separating membrane, as represented by the pressure characteristic according to FIG. 3b, in the first place suggests an inefficient damping action of the damping chamber, but in addition it suggests possible damage to the separation membrane, since it intermittently strikes against the bottom of the damping chamber and may thus be damaged.

On the basis of the comparison of the pressure characteristic of FIG. 3b with the already known pressure characteristic as shown in FIG. 3a, it is possible to determine the current position of the separation membrane in the damping chamber and, in addition, the movement position of the membrane can be adjusted by suitably adjusting the gas pressure in the damping chamber, in such a manner that the membrane will no longer strike against the bottom of the damping chamber upon reaching its maximum positions, but that it will move freely up and down in the damping chamber as a result of the pulsation to be damped.

Thus, the discharge pulsations in a liquid flow through the pipe 5a can be damped in a simple manner, using a simple construction, by means of this embodiment. The indirect method of measuring, i.e. measuring the current gas pressure in the sub-chamber 1a by means of the pressure sensor 19, which measured value is subsequently used for determining the current position of the membrane 4 in the damping device, on the basis of which gas is either supplied to or discharged from the sub-chamber 1a, obviates the need to use a direct, mechanical measuring method (as disclosed in German patent DE 40 31 239).

All the drawbacks that are known in relation to this known measuring method, such as the use of additional parts, which are liable to wear, as well as the specific requirements made as regards the pressure seal, are obviated in this manner.

The supply valve 11 and the discharge valve 12 are so-called gas pressure-actuated valves, since they are opened and closed by means of control air pressurized to, for example, 5-7 bar. To that end the adjusting means according to the invention comprise a pressurised air supply line 25, which supplies control air pressurized to 5-7 bar to the supply valve 11 and the discharge valve 12 via the pneumatic supply lines 25a and 25b, respectively. The electromagnetic actuating solenoids 11a and 12a are provided with a valve mechanism by means of which pressurised control air can be led to the valves 11 or 12 in dependence on control signals 23-22 delivered by the control unit 20. It is also possible to use electrically energised valves as an alternative for air-controlled and air-actuated valves.

One or more safety valves 24a-24b may be mounted in the supply pipe 7 as protection against excessive pressures that may occur in the pipes 7, 8.

1. A device for damping discharge pulsations in a medium being pumped through a system of pipes in a pulsating manner by a displacement pump that operates with a specific discharge characteristic, which device at least comprises
a housing with an at least partially gas-filled damping chamber having a certain volume present therein, which housing can be connected to the system of pipes, in such a manner that an interface layer is present between the medium and the gas in the damping chamber during operation,
which damping chamber has a desired gas pressure characteristic that partially depends on the discharge characteristic of the displacement pump,
wherein the gas volume that is present in the damping chamber varies in time between a minimum compression volume and a maximum expansion volume under the influence of said discharge pulsations during operation,
as well as adjusting means that supply gas to or discharge gas from the damping chamber, characterised in that the adjusting means, in order to achieve an optimised damping of the discharge pulsations, are arranged for determining the current gas pressure characteristic in the damping chamber and comparing the current gas pressure characteristic as determined with the desired gas pressure characteristic of the damping chamber and determining the current position of the interface layer in the damping chamber on the basis of said comparison.

2. A device according to claim 1, characterised in that the adjusting means are arranged for determining the desired gas pressure characteristic of the damping chamber partially on the basis of the discharge characteristic of the displacement pump.

3. A device according to claim 1, characterised in that the adjusting means are arranged for determining the position of the interface layer in the damping chamber at average pressure on the basis of the chamber volume and the compression and expansion pressure associated with the compression and expansion gas volume.

4. A device according to claim 1, characterised in that the adjusting means comprise at least one pressure sensor.

5. A device according to claim 1, characterised in that the interface layer between the pulsating volume flow and the gas is formed by a separating element.

6. A device according to claim 1, characterised in that the damping chamber is an air box.

7. A device according to claim 1, characterised in that the damping chamber is provided with a membrane as the interface layer between the medium and the gas.

8. A method for damping discharge pulsations in a medium being pumped through a system of pipes in a pulsating manner by a displacement pump that operates with a specific discharge characteristic, using a gas volume damping device according to any one or more of the preceding claims, which is connected to the pipe, wherein an interface layer is formed during standstill between the medium and the gas in a gas-filled damping chamber having a certain volume, and wherein the gas volume present in the damping chamber varies in time between a minimum compression volume and a maximum expansion volume under the influence of said discharge pulsations during operation, and wherein gas is supplied to or discharged from the damping chamber for compensating the ideal average gas volume in case of changes in the operating pressures, characterised in that, for the purpose of damping the discharge pulsations, the desired gas pressure characteristic of the damping chamber is determined, the current gas pressure characteristic in the damping chamber is determined and compared with the desired gas pressure characteristic, and in that the average position of the interface layer in the damping chamber is determined on the basis of said comparison.

9. A method according to claim 8, characterised in that the desired gas pressure characteristic of the damping chamber is determined on the basis of the discharge characteristic.

10. A method according to claim 8, characterised in that the current position of the interface layer in the damping chamber is determined on the basis of the discharge characteristic of the pump, the chamber volume and a desired position of the interface layer in the damping chamber at average pressure.

11. A method according to claim 10, characterised in that the compression and expansion pressure associated with the compression and expansion gas volume are determined on the basis of the discharge characteristic of the pump, the chamber volume and the position of the interface layer in the damping chamber at average pressure.
